(19) United States
(12) Patent Application Publication
(10) Pub. No.: US 2005/0108918 A1
(43) Pub. Date: May 26, 2005

(54) Floating waterfowl decoy with reduced pitching and rolling

(76) Inventor: Augusto Franceschini, Tresigallo (IT)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/894,250

(22) Filed: Jul. 19, 2004

(30) Foreign Application Priority Data
Nov. 20, 2003 (IT) PD2003A000280

(51) Int. Cl. A01M 31/06

(52) U.S. Cl. 43/3

(57) ABSTRACT

An improved floating waterfowl decoy is disclosed which includes novel stabilizing apparatus which results in the floating waterfowl decoy presenting a substantially improved appearance on water, with a substantial reduction in the level of unnatural bobbing, pitching, and rolling, thereby presenting a more realistic appearance. The floating waterfowl decoy has a stabilizing weight mounted at the distal end of a fin which extends downwardly from the bottom surface of the body of the floating waterfowl decoy. A lower fin which extends downwardly from the stabilizing weight helps reduce rolling. The bottom surface of the body of the floating waterfowl decoy has a plurality of inwardly extending recesses located therein which create a suction effect when the floating waterfowl decoy is placed into the water.

### BACKGROUND OF THE INVENTION

### Field of the Invention

The present invention relates generally to decoys, and more particularly to an improved floating waterfowl decoy which includes novel stabilizing apparatus which results in the floating waterfowl decoy presenting a substantially improved appearance on water, with a substantial reduction in the level of unnatural bobbing, pitching, and rolling, thereby presenting a more realistic appearance.

The history of the use of waterfowl decoys goes back prior to the mid-nineteenth century, with decoys being used by hunters both on land and floating in the water to attract game birds. Waterfowl decoys were initially made out of wood, and were carved and painted to replicate the appearance of waterfowl, particularly the appearance of waterfowl in the water. Since these early decoys were carved out of wood, they would float in the water, and by floating realistic appearing wooden waterfowl decoys in a pond or stream in a hunting area, live waterfowl could be attracted. The greatest disadvantage these wooden waterfowl decoys had is that they were subject to a substantial amount of bobbing, pitching, and rolling in the water, which made them appear unrealistic and impeded their utility to attract waterfowl.

Another disadvantage such wooden waterfowl decoys had is that they required a substantial amount of work to manufacture, making them expensive. In fact, for some time they have been prized more by collectors as examples of fine workmanship rather than as waterfowl decoys for use in hunting sport birds. By the mid-nineteenth century, alternative constructions for waterfowl decoys were being explored, with hollow tin waterfowl decoys being used as a less expensive alternative to traditional wooden waterfowl decoys. Unfortunately, if more than one of these decoys was used, they would tend to produce a ringing noise whenever they contacted each other in the water, with this propensity to produce a ringing noise alarming rather than attracting any waterfowl in the vicinity. Pinhole leaks would also cause the tin waterfowl decoys to sink, and thus, while they were cheaper, they were not widely adopted.

Improvements driven by technology were not far behind, as illustrated by U.S. Pat. No. 93,293, to Foster, which discloses an inflatable rubber waterfowl decoy, which could be anchored in place in the water. Following the invention of plastic, waterfowl decoys began to be molded from plastic, and were then painted to resemble a wide variety of different waterfowl. These plastic waterfowl decoys had a number of advantages—they were relatively inexpensive to manufacture, could be molded with a high level of detail, and were waterproof and relatively long lasting. Since they were hollow, they floated well, and could be tethered in place with an anchor. An example of such a plastic waterfowl decoy may be found in U.S. Pat. No. 4,023,297, to Jorgenson.

In fact, plastic waterfowl decoys have only one substantial disadvantage—the fact that their hollow molded construction of lightweight plastic results in an inordinate amount of bobbing, pitching, and rolling in a body of water, which makes them appear unrealistic and adversely affects their utility to attract waterfowl. While the other advantages offered by the plastic waterfowl decoys have been perceived as outweighing this significant problem, a number of potential solutions or improvements have been developed by creative individuals over the years. There have been two fundamentally different approaches, the first of which is the use of a stable, wide base and the second of which is the use of a stabilizing weight mounted underneath the body of the waterfowl decoy.

An example of the first approach, using a wide, stable base, may be found in U.S. Pat. No. 5,003,718, to Lenert et al. The Lenert et al. waterfowl decoy body has a wide oval rim and is hollow in order to give the decoy body stability. While the Lenert et al. waterfowl decoy will not pitch and roll as much as some other plastic waterfowl decoys, it will still bob and look unrealistic. Additionally, because of its exceptionally wide body, it does not look realistic, except perhaps when viewed in profile from the side—a view that is unlikely to be seen by waterfowl in the vicinity, to which the Lenert et al. waterfowl decoy will not appear to be realistic.

Examples of the second approach, using a stabilizing weight mounted underneath the body of the waterfowl decoy, may be found in U.S. Pat. No. 3,896,578, U.S. Pat. No. 5,207,757, U.S. Pat. No. 5,172,507, and U.S. Pat. No. 5,832,650, all to Franceschini, all of which are incorporated herein by reference. This approach is similar to the use of a ballast disposed in the keel beneath a sailboat, which lends stability to the sailboat. U.S. Pat. No. 3,896,578 disclosed the use of a water-filled ballast tank located underneath an enclosed hollow body, and U.S. Pat. No. 5,207,757 has a similar approach, but uses a cylindrical ballast tank with a tube or pipe used to fill the tank with water, the water located therein providing the ballast weight. U.S. Pat. No. 5,832,650 uses a weight in a cylindrical ballast tank, and adds a stabilizing adapter which is flat and larger than the bottom of the waterfowl decoy. U.S. Pat. No. 5,172,507 describes an inflatable waterfowl decoy, and has a keel which may be filled with sand, shot, or other ballast.

All four of these patents disclose waterfowl decoys with a ballast tank or keel which is located just underneath the bottom of the body of the waterfowl decoy. The ballast tank or keel functions not to prevent the waterfowl decoy from bobbing, pitching, and rolling in a body of water, but rather to keep the waterfowl decoy upright and properly oriented on the surface of the water.

It is accordingly the primary objective of the present invention that it provide an improved floating waterfowl decoy which includes apparatus which significantly enhances the stability of the floating waterfowl decoy when it is floating on the surface of a body of water. It is a related objective of the present invention that it substantially reduce or eliminate the bobbing, pitching, and rolling that previously known waterfowl decoys have experienced due to their design limitations. It is another related objective that the present invention ensure that the bottom surface of the waterfowl decoy will remain in contact with the surface of the water to an increased degree by increasing the forces that tend to retain the bottom of the waterfowl decoy on the surface of the water, thereby minimizing any tendency of the waterfowl decoy to tip or to cause ripples.

It is an additional objective of the floating waterfowl decoy of the present invention that the stabilizing apparatus be located so that it is not visible when the waterfowl decoy is in use on the surface of water. It is another related objective that the stabilizing apparatus not affect the appearance or dimensions of the waterfowl decoy, so that it may resemble a waterfowl as closely as is possible. It is yet another objective of the present invention that the stabilizing apparatus be relatively compact in size, so as not to make transporting the floating waterfowl decoy of the present invention difficult.

The floating waterfowl decoy of the present invention must also be of construction which is both durable and long lasting, and it should also require little or no maintenance to be provided by the user throughout its operating lifetime. In order to enhance the market appeal of the floating waterfowl decoy of the present invention, it should also be of inexpensive construction to thereby afford it the broadest possible market. Finally, it is also an objective that all of the aforesaid advantages and objectives of the floating waterfowl decoy of the present invention be achieved without incurring any substantial relative disadvantage.

### SUMMARY OF THE INVENTION

The disadvantages and limitations of the background art discussed above are overcome by the present invention. With this invention, a floating waterfowl decoy has been developed which has a design which substantially reduces or eliminates the bobbing, pitching, and rolling that previously known waterfowl decoys have experienced. There are three aspects to the novel design of the floating waterfowl decoy of the present invention: 1. the use of a metal rod which is inserted into a hollow cylindrical ballast housing spaced away from the bottom of the body of the floating waterfowl decoy using a fin; 2. the use of another fin extending beneath the ballast housing, substantially deeper than in any previous design; and 3. the use of a plurality of recesses located in the bottom surface of the body of the floating waterfowl decoy.

The floating waterfowl decoy of the present invention is similar to previously known waterfowl decoys in a number of ways. First, the body of the waterfowl decoy is made by injection molding using conventional plastic materials and technologies. The molded body of the waterfowl decoy may then be painted to match the markings of an actual waterfowl. Like the Franceschini patents mentioned above, the floating waterfowl decoy of the present invention will use a stabilizing weight mounted underneath the body of the waterfowl decoy; however, the design of the stabilizing mechanism of the floating waterfowl decoy of the present invention differs from the designs utilized in the Franceschini patents in manners relating to the first two aspects of the present invention.

The first of these aspects is the only one which finds a parallel in the prior art, since a stabilizing weight was mounted underneath the body of a waterfowl decoy in the Franceschini patents mentioned above. In the Franceschini patents, however, the stabilizing weight was mounted just below the body of the waterfowl decoy, and in the present invention a fin is located intermediate the bottom of the body of the waterfowl decoy and the ballast housing, so that the ballast housing and a metal rod located therein will be spaced further beneath the body of the waterfowl decoy than stabilizing weights were in the past. This acts to provide a further stabilizing effect to the floating waterfowl decoy of the present invention.

The stabilizing weight is a metal rod which may be made, for example, of either iron or lead, or of any other material providing a sufficient amount of weight to accomplish the desired purpose. In the preferred embodiment, the waterfowl decoy is molded without the metal rod being located in the ballast housing, but with the ballast housing having an opening on one end thereof. The metal rod is then inserted into the ballast housing, and a plug is used to seal the open end of the ballast housing.

The second aspect of the floating waterfowl decoy of the present invention is even more immediately noticeable, in that a lower fin extends downwardly beneath the ballast housing. This lower fin helps to substantially reduce the level of rolling which will be experienced by the floating waterfowl decoy of the present invention on water. The fin, the ballast housing, and the lower fin may all be integrally manufactured by injection molding them together with the body of the waterfowl decoy in a single integral assembly.

The third aspect of the floating waterfowl decoy of the present invention is the use of a plurality of recesses located in the bottom surface of the body of the floating waterfowl decoy. The bottom surface of the body of the waterfowl decoy of the present invention is essentially flat, with the plurality of recesses being located in this flat bottom surface. In the preferred embodiment, each of these recesses are either circular or oval in cross-section in a horizontal plane, and extend inwardly into the body of the waterfowl decoy. In a cross-section taken along a vertical plane, each of these recesses may have either a cylindrical (circular cylindrical or oval cylindrical) or a curved cross-sectional configuration.

The result of having the plurality of recesses located in the flat bottom surface of the body of the waterfowl decoy is to create a suction effect at the location of each of the recesses when the waterfowl decoy is placed into the water. This suction effect will tend to substantially reduce the waterfowl decoy bobbing, pitching, and rolling on the surface of the water, thereby giving the floating waterfowl decoy of the present invention an appearance which is substantially more similar to a live waterfowl than are any previously known waterfowl decoys.

Alternately or additionally, the bottom surface of the body of the waterfowl decoy may be slightly concave, with the plurality of recesses being located in the concave bottom surface. However, it is believed that the performance of the recesses is enhanced when the bottom surface of the body of the waterfall is essentially flat rather than being concave. As another alternative or in addition to the plurality of recesses, the outer periphery of the bottom surface of the body of the waterfowl decoy may have a slight downwardly extending ridge, with the rest of the bottom surface being slightly recessed from (located slightly above) this peripheral ridge.

It may therefore be seen that the present invention teaches a floating waterfowl decoy which includes apparatus which significantly enhances the stability of the floating waterfowl decoy when it is floating on the surface of a body of water. The floating waterfowl decoy of the present invention substantially reduces or eliminates the bobbing, pitching, and rolling that previously known waterfowl decoys have experienced due to their design limitations. The floating waterfowl decoy of the present invention also ensures that the bottom surface of the waterfowl decoy remain in contact with the surface of the water to an increased degree due to increases in the forces tending to retain the bottom of the waterfowl decoy on the surface of the water, thereby minimizing any tendency of the waterfowl decoy to tip or to splash and cause ripples.

The floating waterfowl decoy of the present invention utilizes a stabilizing apparatus which is located so that it is not visible when the waterfowl decoy is in use on the surface of water. The stabilizing apparatus of the floating waterfowl decoy of the present invention does not affect either the appearance or the dimensions of the waterfowl decoy, and the waterfowl decoy using this improved stabilizing apparatus resembles a waterfowl as closely as possible. The stabilizing apparatus of the floating waterfowl decoy of the present invention is relatively compact in size, so as not to make transporting the floating waterfowl decoy of the present invention difficult.

The floating waterfowl decoy of the present invention is of a construction which is both durable and long lasting, and which will require little or no maintenance to be provided by the user throughout its operating lifetime. The floating waterfowl decoy of the present invention is also of relatively inexpensive construction to enhance its market appeal and to thereby afford it the broadest possible market. Finally, all of the aforesaid advantages and objectives of the floating waterfowl decoy of the present invention are achieved without incurring any substantial relative disadvantage.

### DESCRIPTION OF THE DRAWINGS

These and other advantages of the present invention are best understood with reference to the drawings, in which:

FIG. 1 is a perspective view from the bottom and side of a floating waterfowl decoy which is constructed according to the teachings of the present invention, showing intermediate and lower fins extending from the bottom surface of the body of the floating waterfowl decoy with a cylindrical ballast housing located therebetween;

FIG. 2 is a side plan view of the floating waterfowl decoy illustrated in FIG. 1, showing the placement of the intermediate and lower fins and the ballast housing beneath the body of the floating waterfowl decoy;

FIG. 3 is a front plan view of the floating waterfowl decoy illustrated in FIGS. 1 and 2, showing the profile of the intermediate and lower fins and the ballast housing beneath the body of the floating waterfowl decoy;

FIG. 4 is a bottom plan view of the floating waterfowl decoy illustrated in FIGS. 1 through 3, showing a plurality of recesses located in the bottom surface of the body of the floating waterfowl decoy and a peripheral ridge extending below the bottom surface;

FIG. 5 is a partially cutaway side view of the floating waterfowl decoy illustrated in FIGS. 1 through 4, showing a metal ballast rod located within the hollow cylindrical ballast housing and a plug used to seal the cylindrical ballast housing to retain the metal ballast rod therein; and

FIG. 6 is a partial cross-sectional view similar to a portion of the view illustrated in FIG. 5, showing the cross-sectional profile of an alternate embodiment configuration recess located in the bottom surface of the body of the floating waterfowl decoy.

### DETAILED DESCRIPTION OF THE PREFERRED EMBODIMENT

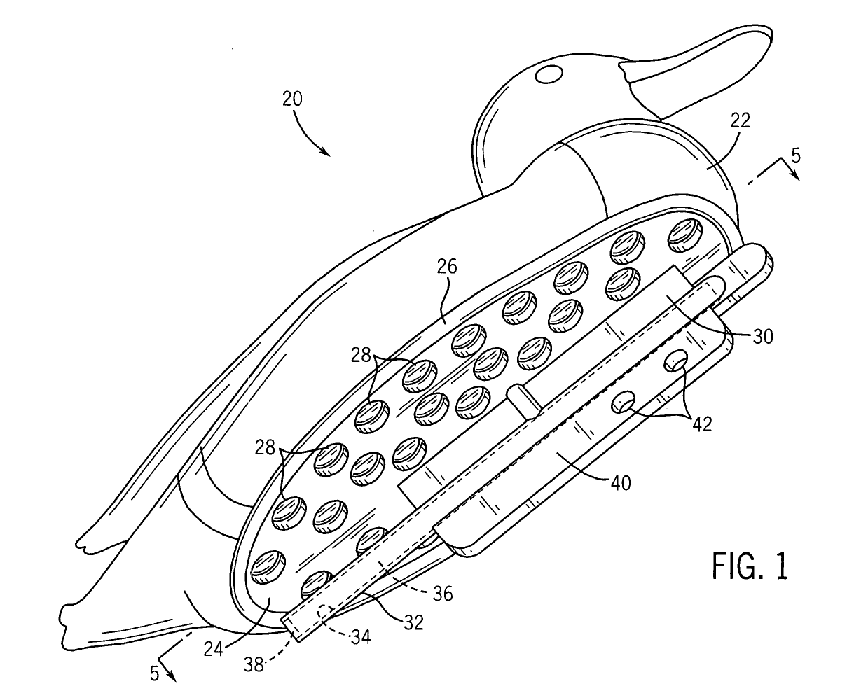

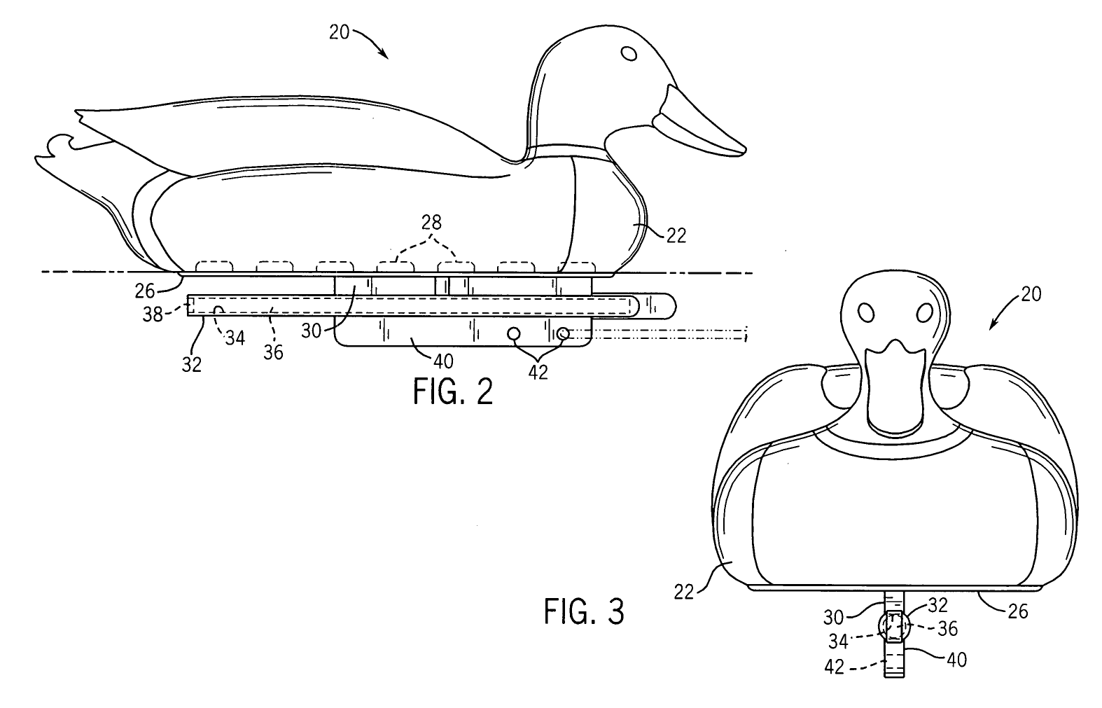

The preferred embodiment of the floating waterfowl decoy of the present invention is illustrated in FIGS. 1 through 5, which show a floating waterfowl decoy 20 which embodies the teachings of the present invention. The floating waterfowl decoy 20 has a waterfowl body 22 which in the preferred embodiment is hollow and is manufactured by injection molding from plastic materials using conventional technology. As will be appreciated by those skilled in the art, the waterfowl body 22 and other elements of the waterfowl decoy 20 will be manufactured in unitary fashion, rather than manufacturing each of these elements separately and then assembling them. The waterfowl body 22 will be painted to match the markings of an actual waterfowl of the type which the waterfowl decoy 20 is designed to attract.

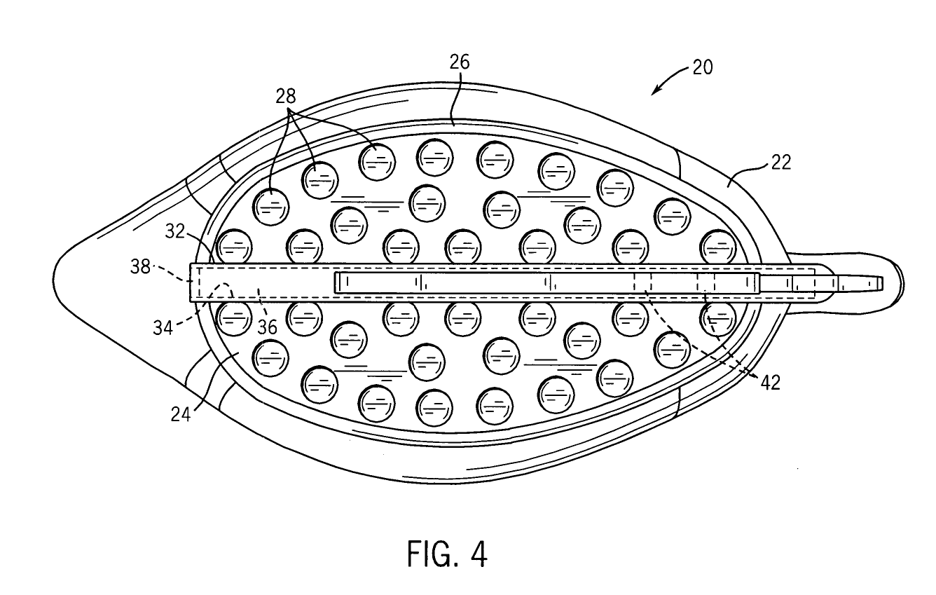

As best shown in FIG. 4, the waterfowl body 22 has a bottom surface 24 which has a generally oval configuration, and which is surrounded by an optional peripheral ridge 26. The bottom surface 24 is recessed within (above) the peripheral ridge 26, as best shown in FIGS. 1, 4, and 5.

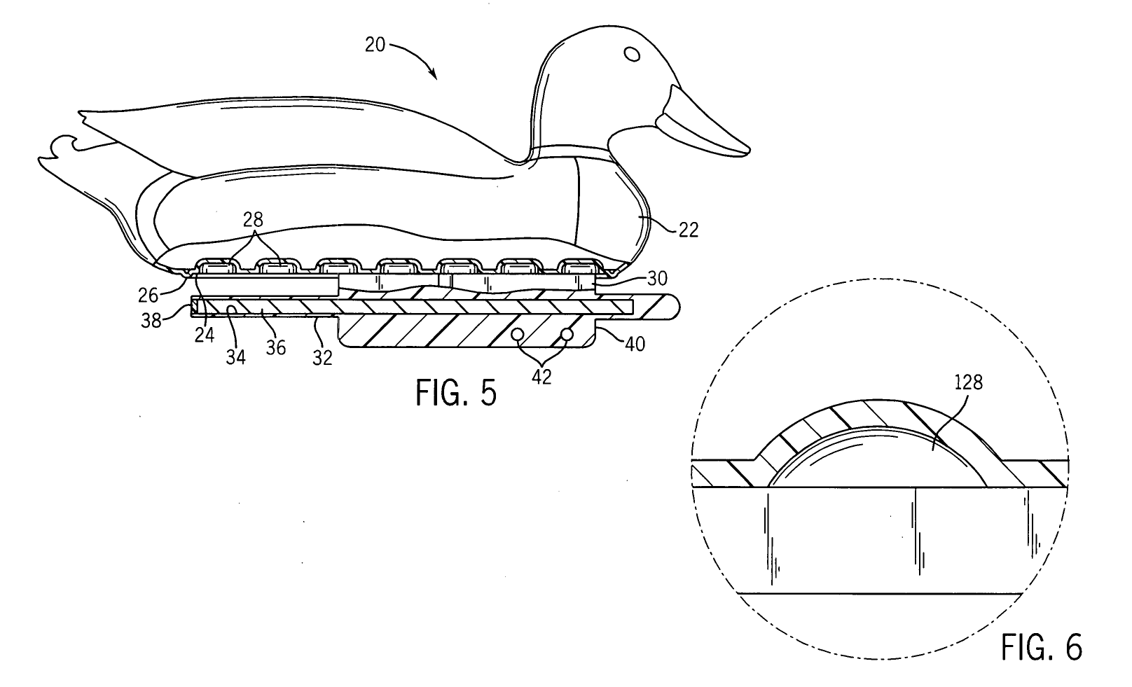

The bottom surface 24 has a plurality of recesses 28 located therein, which recesses 28 are relatively evenly distributed on the bottom surface 24. The recesses 28 are shown in FIG. 3 to have a generally circular configuration when viewed from the bottom of the waterfowl decoy 20, although they may alternately have an oval configuration instead. When the recesses 28 are viewed in cross-section as shown in FIG. 5, it may be seen that they are essentially cylindrical (albeit oval cylindrical) in configuration, with rounded corners in the deepest edges of the recesses 28.

The recesses 28 function to create a suction effect at the location of each of the recesses 28 when the waterfowl decoy 20 is floating on the surface of a body of water, at which point the recesses 28 are located under the water level. This suction effect tends to substantially reduce the tendency of the waterfowl decoy 20 to bob, pitch, and roll on the surface of the water. Reduction or elimination of bobbing, pitching, and rolling on the water has the effect of ensuring that the waterfowl decoy 20 will have a more realistic appearance in use.

Referring briefly to FIG. 6, alternate embodiment recesses 128 are illustrated which have a different cross-sectional configuration. Instead of being cylindrical in cross-section like the recesses 28, the recesses 128 are arcuate in cross-section. Functionally, the recesses 128 operate in precisely the same manner as the recesses 28 illustrated in FIG. 5.

Referring again to the preferred embodiment illustrated in FIGS. 1 through 5, a description of the stabilizing apparatus which is located under the waterfowl body 22 may be commenced. Attached to and extending from the bottom surface 24 of the waterfowl body 22 is a fin 30. The fin 30 is longitudinally oriented with respect to the waterfowl body 22 (the fin 30 extends along the centerline of the waterfowl body 22 from the front end of the waterfowl body 22 to the rear end of the waterfowl body 22), and is mounted to and extends orthogonally from the bottom surface 24 of the waterfowl body 20. The fin 30 extends nearly the full length of the bottom surface 24 of the waterfowl body 20. In cross-section, the fin 30 is relatively narrow, as best illustrated in FIG. 3.

The fin 30 may be viewed as having oppositely disposed proximal and distal sides, with the proximal side of the fin 30 being the side which is connected to the bottom surface 24 of the waterfowl body 20. Connected to the distal side of the fin 30, and thereby spaced away from the bottom surface 24 of the waterfowl body 20, is a hollow cylindrical ballast housing 32. The ballast housing 32 is longer then the fin 30, and extends both in front edge of the fin 30 (and is located under the head of the waterfowl body 22) and behind the rear edge of the fin 30 (and is located under the tail of the waterfowl body 22). The forward end of the ballast housing 32 may be either tapered or blunt.

The ballast housing 32 is closed at the front end thereof, but has an opening 34 at the rear end thereof. The opening 34 in the ballast housing 32 is present to admit a metal rod 36, which is placed in the ballast housing 32 to act as ballast. In the preferred embodiment, the metal rod 36 is not molded into the ballast housing 32, but rather is installed into the ballast housing 32 after the molding operation has been completed. A plug 38 may then be placed into the opening 34 to retain the metal rod 36 in the ballast housing 32. In the preferred embodiment, the plug 38 is adhesively secured in the opening 34 to seal the metal rod 36 within the ballast housing 32.

The implementation of the ballast housing 32 and the metal rod 36 is preferred to facilitate the manufacturing process used to manufacture the floating waterfowl decoy 20. From a manufacturing standpoint, it is simpler to manufacture the floating waterfowl decoy 20 without the metal rod 36 being located inside the ballast housing 32 during the molding process, first performing the molding process and then installing the metal rod 36 into the ballast housing 32. In the preferred embodiment, the metal rod 36 may be made of either iron or lead, although it may be made of any other material having sufficient weight.

Extending from the side of the ballast housing 32 opposite its point of connection to the distal side of the fin 30 is a lower fin 40. As such, the lower fin 40 also extends downwardly away from the bottom surface 24 of the waterfowl body 22. The lower fin 40 and the fin 30 are both in the same plane and as such are parallel, as best shown in FIG. 3. As such, the lower fin 40 is also longitudinally oriented with respect to the waterfowl body 22. The front and rear ends of the lower fin 40 are approximately aligned with the front and rear ends of the fin 30, respectively.

Located near the front end of the lower fin 40 are two apertures 42 which extend therethrough. Either of the apertures 42 may be used to allow the user of the floating waterfowl decoy 20 to attach a string to the floating waterfowl decoy 20 for the purpose of anchoring the floating waterfowl decoy to the bottom of a body of water.

The lower fin 40 will function to increase the resistance of the waterfowl decoy 20 to lateral rotation, and will thereby substantially decrease the tendency of the waterfowl decoy 20 to roll when it is floating on water. The use of the ballast housing 32 containing the metal rod 36, the addition of the lower fin 40, and the presence of the recesses 28 combine to substantially reduce or eliminate bobbing, pitching, and rolling of the waterfowl decoy 20 of the present invention when floating on water. As such, the waterfowl decoy 20 of the present invention more closely resembles a real bird in that it greatly reduces or eliminates movements of the waterfowl decoy 20 which will not appear natural.

It will be appreciated by those skilled in the art that the waterfowl body 22, the fin 30, the ballast housing 32, and the lower fin 40 may be molded in a single piece using conventional thermoforming molding technology. Thus, it will also be appreciated by those skilled in the art that all of the advantages presented by the waterfowl decoy 20 of the present invention are attained without incurring a single disadvantage, and at substantially no increase in the cost of manufacture over conventional decoys which do not present any of the advantages obtained by the present invention.

It may therefore be appreciated from the above detailed description of the preferred embodiment of the present invention that it teaches a floating waterfowl decoy which includes apparatus which significantly enhances the stability of the floating waterfowl decoy when it is floating on the surface of a body of water. The floating waterfowl decoy of the present invention substantially reduces or eliminates the bobbing, pitching, and rolling that previously known waterfowl decoys have experienced due to their design limitations. The floating waterfowl decoy of the present invention also ensures that the bottom surface of the waterfowl decoy remain in contact with the surface of the water to an increased degree due to increases in the forces tending to retain the bottom of the waterfowl decoy on the surface of the water, thereby minimizing any tendency of the waterfowl decoy to tip or to splash and cause ripples.

The floating waterfowl decoy of the present invention utilizes a stabilizing apparatus which is located so that it is not visible when the waterfowl decoy is in use on the surface of water. The stabilizing apparatus of the floating waterfowl decoy of the present invention does not affect either the appearance or the dimensions of the waterfowl decoy, and the waterfowl decoy using this improved stabilizing apparatus resembles a waterfowl as closely as possible. The stabilizing apparatus of the floating waterfowl decoy of the present invention is relatively compact in size, so as not to make transporting the floating waterfowl decoy of the present invention difficult.

The floating waterfowl decoy of the present invention is of a construction which is both durable and long lasting, and which will require little or no maintenance to be provided by the user throughout its operating lifetime. The floating waterfowl decoy of the present invention is also of relatively inexpensive construction to enhance its market appeal and to thereby afford it the broadest possible market. Finally, all of the aforesaid advantages and objectives of the floating waterfowl decoy of the present invention are achieved without incurring any substantial relative disadvantage.

Although the foregoing description of the floating waterfowl decoy of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A floating waterfowl decoy, comprising:
a waterfowl body formed of a closed hollow shell in the configuration of a waterfowl, said waterfowl body having a bottom surface which is intended to rest on the surface of water when the waterfowl decoy is in use;
a fin having a proximal side connected to said bottom surface of said waterfowl body, said fin extending downwardly from said bottom surface of said waterfowl body and having a distal side spaced away from said bottom surface of said waterfowl body;
a ballast member mounted on said distal side of said fin; and
a plurality of inwardly extending recesses located in said bottom surface of said waterfowl body.

2. A floating waterfowl decoy as defined in claim 1, wherein said waterfowl body is painted to resemble the markings of a waterfowl to be attracted by the waterfowl decoy.

3. A floating waterfowl decoy as defined in claim 1, wherein said bottom surface is essentially flat in overall configuration, with said recesses being located in said flat bottom surface.

4. A floating waterfowl decoy as defined in claim 1, wherein said bottom surface is slightly concave in overall configuration, with said recesses being located in said concave bottom surface.

5. A floating waterfowl decoy as defined in claim 1, wherein said fin is centrally located on said bottom surface of said waterfowl body and extends in a longitudinal direction on said bottom surface of said waterfowl body.

6. A floating waterfowl decoy as defined in claim 1, wherein said fin extends orthogonally from said bottom surface of said waterfowl body.

7. A floating waterfowl decoy as defined in claim 1, wherein said ballast member comprises:
a hollow ballast housing mounted on said distal side of said fin; and
a ballast weight located inside said hollow ballast housing.

8. A floating waterfowl decoy as defined in claim 7, wherein said hollow ballast housing has a cylindrical configuration.

9. A floating waterfowl decoy as defined in claim 7, wherein said ballast weight of made of metal material which may optionally be iron or lead

10. A floating waterfowl decoy as defined in claim 7, wherein said ballast member additionally comprises:
a retaining member for enclosing said ballast weight inside said hollow ballast housing.

11. A floating waterfowl decoy as defined in claim 10, where said hollow ballast housing has an aperture located therein through which said ballast weight may be inserted, and wherein said retaining member comprises:
a plug member which may be adhesively or otherwise secured in said aperture in said hollow ballast member to retain said ballast weight inside said hollow ballast housing.

12. A floating waterfowl decoy as defined in claim 1, additionally comprising:
a lower fin extending from the side of said ballast member which is opposite said fin, said lower fin thereby extending further from said bottom surface of said waterfowl body.

13. A floating waterfowl decoy as defined in claim 12, wherein said fin and said lower fin are coplanar.

14. A floating waterfowl decoy as defined in claim 12, wherein said lower fin has an aperture extending laterally therethrough for use in anchoring the waterfowl decoy.

15. A floating waterfowl decoy as defined in claim 12, wherein said ballast member comprises:
a hollow ballast housing mounted on said distal side of said fin; and
a ballast weight located inside said hollow ballast housing;
and wherein said waterfowl body, said fin, said hollow manufactured in unitary fashion.

16. A floating waterfowl decoy as defined in claim 1, additionally comprising:
a peripheral ridge located around the periphery of said bottom surface and extending downwardly from said bottom surface such that said bottom surface inside said peripheral ridge is slightly recessed from said peripheral ridge.

17. A floating waterfowl decoy as defined in claim 1, wherein said inwardly extending recesses are circular or oval in cross-section in a plane which is horizontal with reference to the orientation of said waterfowl decoy.

18. A floating waterfowl decoy as defined in claim 1, wherein said inwardly extending recesses are essentially cylindrical or have a curved cross-sectional configuration in a plane which is vertical with reference to the orientation of said waterfowl decoy.

19. A floating waterfowl decoy as defined in claim 1, wherein said fin and said inwardly extending recesses are arranged and configured to substantially reduce or eliminate bobbing, pitching, and rolling of said waterfowl decoy on water.

20. A floating waterfowl decoy, comprising:
a waterfowl body formed of a closed hollow shell in the configuration of a waterfowl, said waterfowl body having an essentially flat bottom surface which is intended to rest on the surface of water when the waterfowl decoy is in use;
a fin having a proximal side connected to said bottom surface of said waterfowl body, said fin extending downwardly from said bottom surface of said waterfowl body and having a distal side spaced away from said bottom surface of said waterfowl body;
a hollow ballast housing mounted on said distal side of said fin;
a ballast weight located inside said hollow ballast housing;
a lower fin extending from the side of said ballast member which is opposite said fin; and
a plurality of inwardly extending recesses located in said bottom surface of said waterfowl body.

21. A floating waterfowl decoy, comprising:
a waterfowl body in the configuration of a waterfowl, said waterfowl body having a bottom surface;
a fin extending downwardly from said bottom surface of said waterfowl body, said fin having a distal side spaced away from said bottom surface of said waterfowl body;
a ballast member mounted on said distal side of said fin; and
a plurality of inwardly extending recesses located in said bottom surface of said waterfowl body.

22. A method of making a floating waterfowl decoy, said method comprising:
forming a waterfowl body of a closed hollow shell in the configuration of a waterfowl, said waterfowl body having a bottom surface which is intended to rest on the surface of water when the waterfowl decoy is in use;
connecting a fin on a proximal side thereof to said bottom surface of said waterfowl body, said fin extending downwardly from said bottom surface of said waterfowl body and having a distal side spaced away from said bottom surface of said waterfowl body;
mounting a ballast member on said distal side of said fin; and
locating a plurality of inwardly extending recesses in said bottom surface of said waterfowl body.
